(19) United States
(12) Patent Application Publication
(10) Pub. No.: US 2017/0104630 A1
(43) Pub. Date: Apr. 13, 2017

(54) System, Method, Software, and Apparatus for Computer Network Management

(71) Applicant: Defensative, LLC, Reston, VA (US)

(72) Inventors: Kenneth Shelton, Reston, VA (US); Scott Suhy, Reston, VA (US)

(73) Assignee: Defensative, LLC, Reston, VA (US)

(21) Appl. No.: 15/287,650

(22) Filed: Oct. 6, 2016

Related U.S. Application Data
(60) Provisional application No. 62/239,870, filed on Oct. 10, 2015.

(51) Int. Cl. H04L 12/24; H04L 12/721; H04L 29/12

(52) U.S. Cl. CPC H04L 41/0816; H04L 61/103; H04L 45/38

(57) ABSTRACT

Systems, methods, software, and apparatus for managing computer networks are described where a combination of high levels of technical expertise and access rights preclude current users from installing mandated IDS and network management tools on the small office, home office (SOHO) and small branch installations. In some embodiments, the invention implements network packet capture and distributed packet and stream analysis using “hacker” techniques that redirect existing network packet flows to the network management and monitoring appliance without requiring the network user to have authorized access to reconfigure the router. The appliance then optionally forwards the redirected traffic to its destination, so the insertion of the appliance and its monitoring and management functions are transparent to the users.

### CROSS-REFERENCE TO RELATED APPLICATIONS

This application claims priority under 35 U.S.C. §119(e) to provisional U.S. patent application Ser. No. 62/239,870 filed 10 Oct. 2015, the entire disclosure of which is incorporated herein by reference in its entirety and for all purposes.

### NOTICE OF COPYRIGHT

Portions of this patent application include materials that are subject to copyright protection. The copyright owner has no objection to the facsimile reproduction by anyone of the patent document itself, or of the patent application, as it appears in the files of the United States Patent and Trademark Office, but otherwise reserves all copyright rights whatsoever in such included copyrighted materials. The following notice shall apply to this document: Copyright © 2016, Defensative, Inc. All rights reserved.

### BACKGROUND OF THE INVENTION

### Field of the Invention

Network management and intrusion detection systems have become commonplace tools for managers of enterprise networks to detect and manage the ever-increasing number of network security challenges. Installing network management (“NMS”) and intrusion detection (“IDS”) systems typically requires specialized knowledge by the installer, who must configure routers, switches, and firewalls; so that these systems are inserted into the low-level packet flows of the network, where they can intercept, inspect, and monitor all of the network traffic. Interpreting and determining required actions from the packet intercepts requires still more specialized expertise that is typically not available except in larger enterprises. These systems are further limited in that they typically require all of the managed network traffic to pass through their intercept and inspection in order to make determinations regarding the nature of network traffic (e.g., proper or improper).

As businesses outsource their network functions, and the network providers are now managing their customer premise routers and firewalls (and installing all-on-one router/firewall/switches for their premise equipment), there is no ability for small and remote office users and network managers to configure their switches, routers, and firewalls, in part because of the high level of skill required to make these configurations, and because the end users/customers do not have the access rights to these devices in order to change their configurations. “Black hat” (hacker) technologies are often used to exploit network systems and intercept network traffic in unauthorized ways. One such technology is called “ARP spoofing,” and relies upon a weakness in the Address Resolution Protocol (ARP) that routers and switches used to determine network routings. These technologies are well known and have been developed into freeware packages such as “ettercap” that implement the technique. Ettercap/ARP spoofing operates by broadcasting “spoofed” MAC/IP address mapping notifications to the router, which updates its internal ARP tables with the “spoofed” information. Subsequent packets to that MAC/IP address will be redirected to the spoofing system as illustrated in FIG. 1A and FIG. 1B.

In FIG. 1A, a typical network router/switch (100) and its attached workstations (110, 120, 130, connected to interfaces 1,2,3 respectively) is illustrated, with the networking MAC and IP addresses of the attached workstations called out for each workstation. The ARP table of the router is also illustrated, showing the mapping of the ARP, IP, and interface in normal operation. Traffic flowing between client 110 and client 120 (arcs (1) and (2)) is sent by client 110 to the router, where the IP address is translated to a MAC address (198.1.1.3 is translated to MAC DEF123 using the ARP table), and then directed to client 120 on interface 2 using the same table. Return traffic from client 120 to client 110 follows a similar pattern.

FIG. 1B illustrates the same network after an ARP spoofing attack by Attacker 130. The immediate effect of the ARP spoofing attack is the reconfiguration of router 100 ARP table to replace all workstations MAC targets with the MAC address of the attacker. This has the effect of causing network traffic (arc (1)) between client 110 and client 120 to be redirected at the router to Attacker 130. Attacker 130 then retransmits the traffic to its intended destination (arc (2)), while return traffic (arc (3)) is again redirected to attacker 130, which then retransmits the traffic to its original destination (arc (4)).

ARP spoofing alone does not provide the complete packet streams required for NMS and IDS operation and are inherently not persistent. The ARP spoofing result is overwritten the next time the spoofed machine rebroadcasts its ARP information. Additional techniques are required to maintain a persistently spoofed packet stream, to receive all of the packets sent over the network, and to manage the retransmission information.

The combination of high levels of technical expertise required combined with the lack of access rights preclude current users from installing mandated IDS and network management tools on the small office, home office (SOHO) and small branch installations. Alternative mechanisms are needed to enable these types of systems. The present invention addresses these and other needs.

### SUMMARY OF EMBODIMENTS OF THE INVENTION

In a first aspect, the present invention provides a computer-controlled electronic system for electronically managing computer network traffic among computers in an electronic computer communications network In one embodiment, the system comprises a computer-controlled electronic router device for enabling communications between one or more computers on an internal computer network with one or more computers on an external computer network, the router including at least one internal electronic interface configured to enable communications between a computer in the internal computer network with the router, and the router having an external electronic interface configure to enable the router to communicate with one or more devices on the external computer network; a management-intercept server in electronic communication with the external electronic interface of the router, the management-intercept server being configure to provide instructions and programming to a network management and monitoring device and receive information about network operations collected and processed by the network management and monitoring device; and a network management and monitoring device operably connected to the internal electronic interface of the router configured to receive provide instructions and programming from the management-intercept server and send information about network operations collected and processed by the network management and monitoring device to the management-intercept server, and the network management and monitoring device being configured to configure a routing change in the router to thereby persistently inserting itself into packet flows through the router.

In a second aspect, the present invention provides a method for computer controlled management of computer network traffic among computers in an electronic computer communications network having a computer-controlled electronic router device for enabling communications between one or more computers on an internal computer network with one or more computers on an external computer network, the router including at least one internal electronic interface configured to enable communications between a computer in the internal computer network with the router, and the router having an external electronic interface configure to enable the router to communicate with one or more devices on the external computer network In one embodiment, the method comprises initiating a management-intercept server in electronic communication with the external electronic interface of the router, the management-intercept server being configure to provide instructions and programming to a network management and monitoring device and receive information about network operations collected and processed by the network management and monitoring device; initiating a network management and monitoring device operably connected to the internal electronic interface of the router configured to receive provide instructions and programming from the management-intercept server and send information about network operations collected and processed by the network management and monitoring device to the management-intercept server, and the network management and monitoring device being configured to configure a routing change in the router to thereby persistently inserting itself into packet flows through the router; and intercepting and processing electronic communications traffic reaching the router using the network management and monitoring device.

### BRIEF DESCRIPTION OF THE DRAWINGS

Exemplary embodiments of the present invention are described herein with reference to the following drawings, in which:

FIG. 1A depicts a typical prior art a typical network router/switch and its attached workstations, interfaces, and routing paths, operating under normal conditions as known in the prior art.

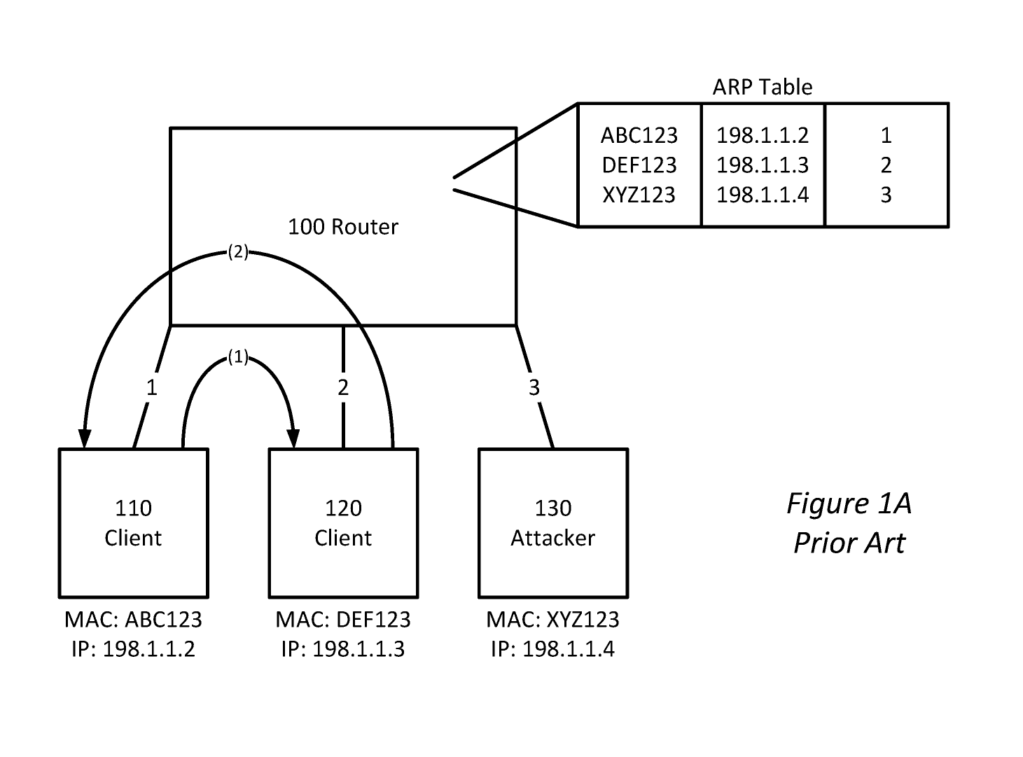

FIG. 1B illustrates the same network after an ARP spoofing attack by Attacker 130 as known in the prior art.

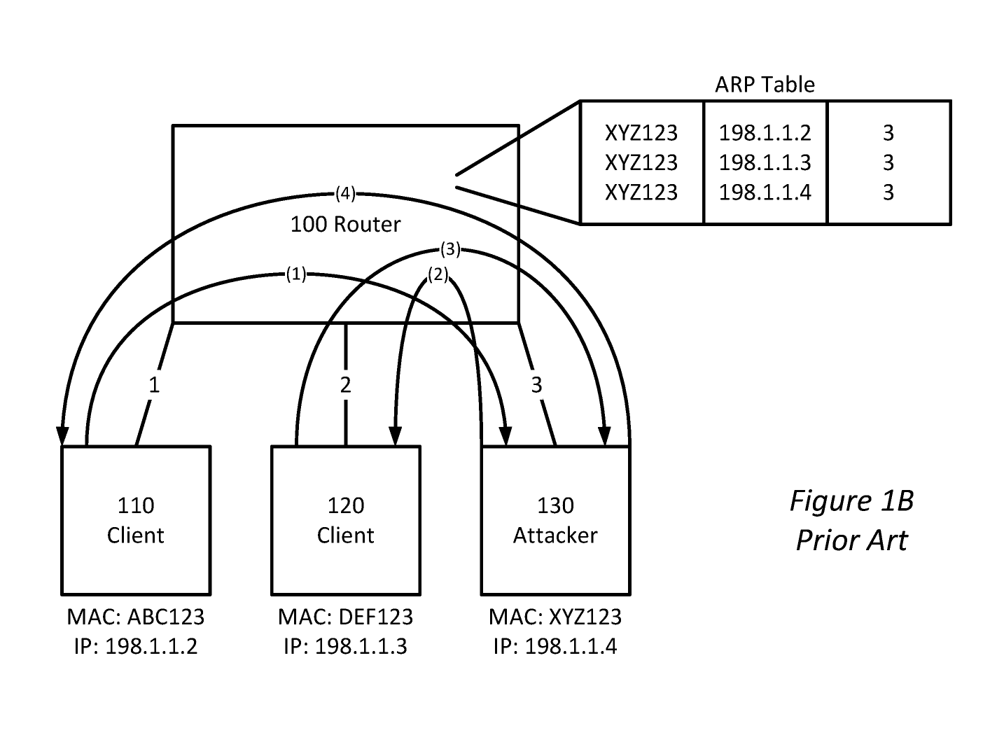

FIG. 2 depicts an exemplary network comprising an intercept and monitoring device of the present invention.

FIG. 3 illustrates in more detail the components of an intercept and monitoring device of the present invention illustrated in FIG. 2.

FIG. 4 illustrates an exemplary management/intercept server of the present invention.

### DETAILED DESCRIPTION OF SOME EMBODIMENTS OF THE INVENTION

### Overview

The system provides an auto-configuring and managing network management and monitoring appliance and server arrangement for small and home office (SOHO) configurations that provides the benefits of having dedicated network monitoring and intrusion detection systems to small and home offices. One challenge of configuring small and home office networks is a lack of authorized access to the network interface router/switch to install/configure the networking routing changes required to make traditional network monitoring and intrusion detection systems operable. The system described herein implements network packet capture and distributed packet and stream analysis using “hacker” techniques that redirect existing network packet flows to the network management and monitoring appliance without requiring the network user to have authorized access to reconfigure the router. The network management and monitoring appliance is connected to a router/switch (using wired or wireless networking) to which it does not have credentials/ability to alter the router/switch programming, redirects the network traffic passing through that router/switch to itself, and then monitors the redirected traffic for network management and intrusion detection purposes. The appliance then optionally forwards the redirected traffic to its destination, so the insertion of the appliance and its monitoring and management functions are transparent to the users.

Specifically, the network management and monitoring appliance uses one or more rules, described in more detail hereinbelow, that enable processing of redirected network traffic for network misconfigurations, malware information exfiltration and/or malware control traffic, information exfiltration, or other types of unexpected/inappropriate network traffic. The appliance communicates at least one of the packets comprising the intercepted network packets, summaries of the intercepted packets and/or packet streams, or excerpts comprising portions of one or more network packet streams to an analysis server for additional analysis, reporting, and possible remedial action. In some embodiments, the appliance may take immediate remedial action to mitigate specific threats. In some embodiments, the rules are downloaded from a repository.

In one exemplary embodiment, the network management and monitoring appliance configures a routing change in the router, persistently inserting itself into the packet flows. In cases where the network management and monitoring appliance does not have the permissions necessary to configure the routing change in the router, it uses “ARP Spoofing” to cause the router to redirect the network traffic absent a formal configuration change. ARP spoofing is a transient change in the router that redirects network traffic until the ARP table in the router is reset, either by resetting the router or though the normal operation of the router and the ARP protocol. In some embodiments described herein, the changes made in the router that enable traffic redirection of network traffic through the router to the network management and monitoring appliance are transient in nature; so the network management and monitoring appliance takes the necessary steps to maintain packet redirection, by periodically reinserting itself into the packet flows. Because the changes are transient, if the router/switch is rebooted, the monitoring appliance recognizes that the router has been restarted and automatically reinserts itself into the packet flow by reasserting the ARP spoofing for all known devices, and once re-established in the packet flow, continues processing network packets. Thus, the network management and monitoring appliance is able to maintain a persistent redirection of network packets for the purposes of management, monitoring, and intrusion detection.

One of the challenges for the network management and monitoring appliance is to make monitoring and analysis on partial network packet captures. Network packets are typically found in “streams”, comprising a sequence of packets traveling from a first network address (e.g., IP address and port number) to a second network address. Packets in a stream are sometimes associated with each other (as in TCP/IP) or are independent (such as UDP packets). Other network management packets (e.g., ICMP, ARP, WINS, DNS, NETBIOS, DHCP, device discovery) may also be found on the network and provide valuable information regarding the architecture and configurations of devices attached to the network.

Each of these packet types are received, processed by the network management and monitoring appliance, packet streams identified, and network configuration information extracted from the packets as appropriate.

Traditional network management and intrusion detection systems rely on having access to all network traffic; the techniques used for the insertion of the network management and monitoring appliance into the network are typically lossey (e.g., not all packets in a packet stream are present), rendering traditional methods unusable that rely upon complete packet streams. The network management and monitoring appliance monitoring techniques have been altered to permit monitoring and intrusion analysis of packets in spite of lost packets. This represents a substantial change over traditional monitoring and intrusion analysis techniques, which regard lost packets as a fault in their own right.

Small and home office networks are often characterized by their relatively lower speed connection to the internet. Speeds of 10-20 Mbps are common. Packet capture and analysis, and in particular, distributed analysis requires much higher bandwidth to be effective, as the distributed analysis software requires much of the packet traffic in order to be effective. The network management and monitoring appliance addresses these bandwidth challenges by locally capturing network traffic, performing initial matching and analysis on the basis of a configurable rule set, and sending abstracted or summarized information along with specifically requested packet captures to the analysis server for further analysis. In this way, the effects of limited bandwidth on capture and forwarding of captured packets are mitigated while maintaining full reporting to the analysis server.

The analysis servers operate on the summaries and captured packets. They maintain a profile of “normal” traffic for a specific small or home office network. This profile is encoded into a set of rules that represent “normal” packet traffic patterns, which are sent to the monitoring appliance for use in traffic classification. This customizes the monitoring appliance's operation in order to limit the transmission of information about well known (and previously analyzed) network traffic. For example, if a particular PC in a small office regularly connects to a well known server on the Internet that provides accounting services (e.g., Quickbooks Online), the analysis server may create a rule that limits or stops reporting of connections between that PC and the online service.

The combination of these features and techniques provide unique and novel capabilities for network monitoring and intrusion detection.

### Exemplary System Architecture

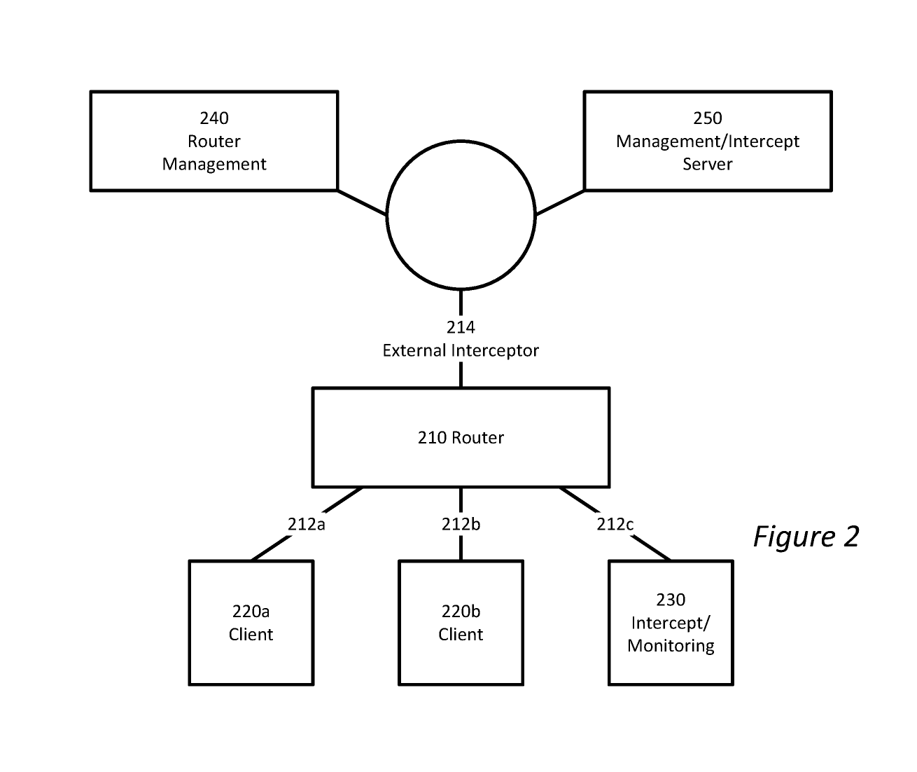

FIG. 2 is an exemplary network comprising a network management and monitoring device of the present invention in accordance with one embodiment of the invention. This network comprises a SOHO or other router (210), further comprising at least one internal interface (e.g., 212a, 212b, 212c) and at least one external interface (214), the internal interface connected to an internal network, and an external interface connected to the Internet (cloud), one or more Client devices (e.g., 220a, 220b), internal network connection (wired or wireless) connecting client devices to the SOHO or other router, and the network management and monitoring device (230), operably connected to the router's inside interface. The router further comprises a processor or FPGA, instructions for the processor and/or FPGA, and internal memory, including a routing table effective to identify the MAC addresses of the client devices and the internal network ports that each client is connected to.

Client devices may be workstations, laptops, or other computers of traditional manufacture, or may be an appliance such as a cell phones, media player, IP telephone, or other similar network connected devices that communicates on a network using standard Internet protocols.

The network further comprises an optional external router management entity (240) and a management/intercept server (250), both connected to the Internet cloud. The external router management entity typically operates to configure and manage the SOHO router, or provides the initial router configuration of SOHO routers that are not actively managed. The management/intercept server (250) communicates with the network management and monitoring appliance in order to provide instructions and customized programming to the network management and monitoring appliance, and to receive and process information about the network operations collected and processed by the network management and monitoring appliance. In particular, this information may include: summaries of packet streams (e.g., endpoint IP and port address information, packet counts, bytes transferred (in either or both directions, if appropriate)), captured packet for further inspection, and/or alert information indicating that anonymous packet traffic was detected. A plurality of local networks and SOHO routers (210) may be connected with a single management/intercept server (250).

Applications network packet traffic traditionally flows from a client (e.g., 220a) through the SOHO router (210) to other clients (e.g., 220b) or via the external interface (214) to a server on the internet (not shown), with response traffic returning via a reverse path. Often, this application layer network traffic takes the form of HTTP or HTTPS web traffic, which is sent as a series of packets (and response packets) that together define a session. Often, these connections are created at the TCP layer, although some media streaming sessions are created using datagram-based (e.g., UDP) protocols. Other intercepted network traffic includes protocols from the transport and link layers of the Internet protocol suites.

In some embodiments, the network management and monitoring device of the present invention in virtualized on one or more servers. In some embodiments, the management/intercept service is virtualized (e.g., AWS) on one or more servers, and can be implemented as a so-called “cloud service”.

In a first example, a client (computer) connects to a popular news reporting site (e.g. CNN) and downloads web pages that represent the text and graphics of the news stories. In some cases, some of the sessions are between the client and CNN (to fetch the web page), and other sessions are between the client and a CNN-contracted edge content distribution network (CDN) (e.g. Akamai) for pictures that are part of the web page. The network traffic to/from the client is intercepted by the network management and monitoring appliance. The packets to/from the CNN web site are consolidated as a first session by the network management and monitoring server based upon their TCP/IP session information (e.g IP address and port), and the packets to/from the CDN are consolidated as separate sessions based upon their TCP/IP session information. The network management and monitoring appliance may, depending upon the rules downloaded into it, ignore these sessions, consolidate these sessions into a single (e.g. CNN) session for reporting, or report each session independently.

In a second example, a client connects to a VOIP phone service in order to place a call. The SIP traffic between the telephony software running on the client is assembled as a first session, the RSVP call management session is assembled as a second session, and the UDP packet streams that carry the voice are assembled as a third session. The session assembly rules are taken from packet inspection of the SIP and RSVP traffic, as well as rules downloaded into the network management and monitoring appliance by a management server. The network management and monitoring server may, depending upon the rules downloaded into it, ignore these sessions, consolidate these sessions into a single telephony session for reporting, or report each session independently.

In a third example, the network management and monitoring appliance detects network management traffic (such as device location requests) that indicates that there is a misconfiguration of one or more network client devices. For example, if a WINS request packet is discovered looking for a server or address that is not part of the network, this may indicate either a misconfiguration of a client device, or may indicate a network-based attack. In either case, the WINS request containing the anonymous request may be captured and forwarded for further analysis.

In a fourth example, the network management and monitoring appliance detects anomalous network packet traffic, such as traffic with “spoofed” IP addresses, or detects network packet traffic using an unauthorized protocol (e.g. IIRC traffic), or network packet traffic directed to a known “bad” site (such as a botnet command and control server). In each of these cases, the “bad” network packet traffic is identified on the basis of one or more rules (e.g. presence of a specific rule that is used to identify the anomalous traffic, or the absence of a specific rule permitting the traffic). Once identified as anomalous, the network management and monitoring appliance may take one or more actions, including blocking the offending traffic by failing to forward the offending packets to its destination, capturing the traffic for further analysis, generating an alert, or other actions as may be specified by a rule.

In each of these cases, where protocol protections (e.g. encryption) permit it, the network management and monitoring appliance may more fully inspect packet traffic (e.g. deep packet inspection) it intercepts in order to determine session pairings (e.g. UDP to RSVP session matching) and to determine if errors occurred during processing at the higher protocol layers (e.g. a SIP unable to authenticate error). The network management and monitoring appliance uses its deeper packet inspection findings to further enhance or consolidate network traffic reporting.

In a fifth example, a SIP session between a client device (e.g. a phone) and a VOIP service in the Internet fails because of an authentication error. The network management and monitoring appliance determines the cause of error using deep packet inspection to identify and parse out the reported cause of the connection error and report this error and its cause for remediation by sending information about the stream and packet to the managing/intercept server (e.g. reprogramming the SIP phone with new credentials). The remediation steps may be performed by the managing/intercept server, or may be performed out-of-band by a technician.

In a sixth example, the network management and monitoring appliance uses deep packet inspection to monitor network packet traffic for specific electronic content that is not permitted to be sent outside the SOHO network. For example, a file upload may be inspected packet by packet for the text “Official Use Only” and, if found, the results may be record and reported, and/or the session immediately determined by the network management and monitoring appliance (by no longer forwarding packets related to the session).

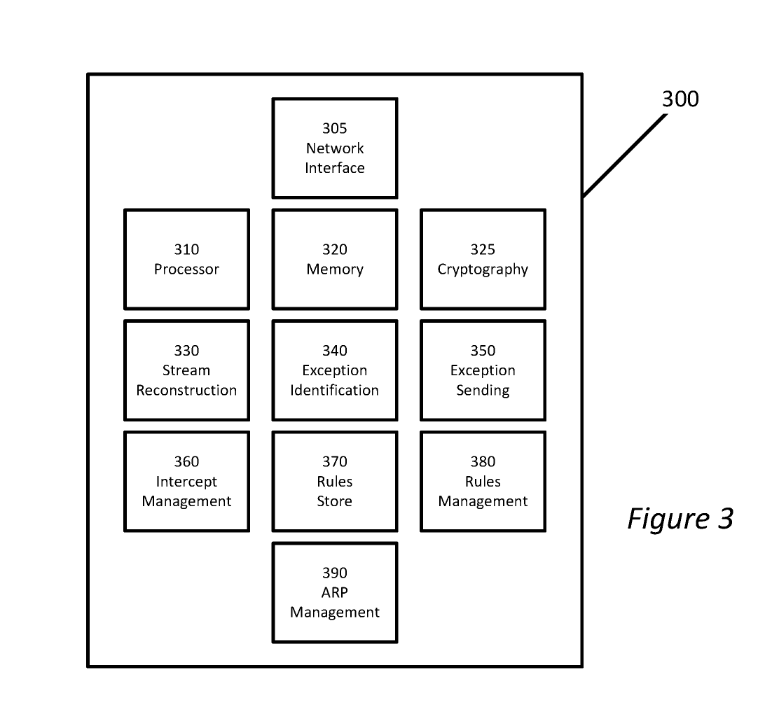

FIG. 3 illustrates in more detail the components of an intercept and monitoring device as described in FIG. 2. The intercept and monitoring device (300) comprises a processor and/or FPGA (310), one or more memories (320) (persistent and/or non-persistent, e.g. RAM, ROM, EEPROM, hard disk), at least one network interface (305), and computer software executed by the processor and/or FPGA effective to send and receive network traffic over the network connection. The intercept and monitoring device communicates with the router (FIG. 2, 210) in order to send/receive intercepted packets with the local network and the reporting and rules traffic with the reporting management/intercept server (FIG. 2, 250).

The software components of network management and monitoring appliance include components that manage rules and interception of packet traffic on the local network. These components include an intercept management component (360) that is effective to receive, manage, and retransmit intercepted network packets, rules storage component (370) which provides for the persistent storage of downloaded rules, rules management component (380) which manages rules, including downloading, refreshing, and similar operations, and ARP management component (390), which manages the persistent insertion of the intercept and monitoring device into the local network's network traffic flows.

The intercept management component (360) receives network packets from the network interface (305), categorizes them in accordance with one or more rules, and forwards them to an appropriate component for further servicing. In addition, it retransmits the packets back on the network for subsequent delivery after substituting in the “correct” MAC address to ensure the packet is delivered to the correct interface of the router. Thus, a packet received from the router that was redirected to the network management and monitoring appliance that was originally destined for a server on the internet will have the MAC address of the external interface of the router placed into the packet (replacing the MAC of the intercept and monitoring device) and the packet will be retransmitted to the network. The router will then route the packet in accordance with the MAC/interface tables within the router and the packet will be sent out the external interface. A copy of the packet is also passed to other components of the network management and monitoring appliance (which component the packet is passed to depends upon packet type). Network traffic from the external interface is handled in the same way, with the MAC of the destination machine substituted into the packet and the packet retransmitted for delivery.

Rules storage (370) and Rules Management (380) components operate together in order to download, store, and make available to other components of the system the rules governing intercept, classification, condensation/compression, and forwarding of packet and session traffic information from the intercept and monitoring device to the management/intercept server. In typical operation, the rules management component identifies rules provided by the management intercept server, downloads these rules and stores them in the rules storage component, which in turn stores them in a persistent memory of the intercept and management device. The rules management component then expands the rules (if necessary), makes available any downloaded rule and packet processing extensions that were included with the downloaded rules and additional processing information derived from the downloaded rules, and makes these rules, extensions, and information available to the various components of the intercept and monitoring device.

The ARP management component (390) of the intercept and monitoring device manages the persisted insertion of the intercept and monitoring device into the local network packet flow. In simplest form, the ARP management component performs an ARP spoofing attack to poison the ARP cache on the router (and on other client machines) for all IPs in the local network by sending spoofed ARP packets naming the intercept and monitoring device as the MAC that services each IP address in the local network, monitors network traffic for ARP traffic and responds to that traffic using spoofed information, and periodically “repoisons” the ARP caches by broadcasting unsolicited spoofed ARP information to the network.

The network management and monitoring appliance further includes a stream reconstruction component (330) for the reduction of intercepted packets into streams and for merging related streams into sessions for reporting purposes, an exception identification (340) component for determining of problems or operating exceptions are present (and for comparing streams against the rules) and an exception sending component (350) that manages communications with one or more management/intercept servers (FIG. 2, 250) as described above.

The stream reconstruction component (330) identifies and collapses sequences of packets into a single session identifier, and triggers identification processing extensions as they match incoming packets as has been configured for the intercept and monitoring device by the rules management component. For example, if a TCP/IP session is established, the packets may be matched using information in the TCP/IP headers such as the sequence numbers and port addresses. This permits the system to identify related packets from a TCP/IP session, and identify whether the TCP/IP session as a whole is interesting or not on the basis of one or more rules. If a session is identified as “interesting,” information about the session is forwarded to the exception sending component (350) for further processing. In the case of stateless packets, such as those associated with a UDP session, it is still possible for the sequence of packets to comprise a “session.” For example, a VOIP session may comprise a UDP-based voice stream delivery mechanism where the session is defined as a sequence of UDP packets between two endpoints between the time the “session” starts and the “session” ends, as indicated by other elements of the VOIP protocol. The UDP voice session may be identified as a session on the basis of a rule, and an additional packet processing extension that parses the SIP session that identifies the start and end of call information.

The exception identification component (340) operates to identify exceptions that should be monitored and/or reported to the management intercept server (FIG. 2, 250). The exceptions may be rule based, such as connection attempts to an unauthorized and/or inappropriate endpoint, or may be associated with content within one or more packets. If the exception is associated with packet contents, an additional packet processing extension may be used to inspect the detail of one or more packets and/or sessions. In some cases, the exceptions are planned for (such as a failed call in the VOIP example above is reported in the SIP session information, which is parsed by a packet processing extension as described above), in others, the exception is a failure or presence of one or more packets or sessions as defined by one or more rules.

The exception sending component (350) take exceptions and stream errors from the stream reconstruction, exception identification, and intercept components, packages them, and transmits them to a management/intercept server (FIG. 2, 250) for further processing. It then receives the response back from the management/intercept server and implements the requested action. In some implementations, the response is nearly immediate, and is received in response to the sending action. In other implementations, the response is delayed and is sent asynchronously by the management/intercept server. In still other implementations, the exception sending component polls the management/intercept server to check for outstanding responses.

Note that an exception sending component may communicate with one or more management/intercept servers, either on the basis of the rule and/or exception being sent, or upon the basis of a management/intercept server's availability. The exception sending component may use the cryptography component (325) to establish a secure session and/or validate the identity of a management/intercept server it connects with.

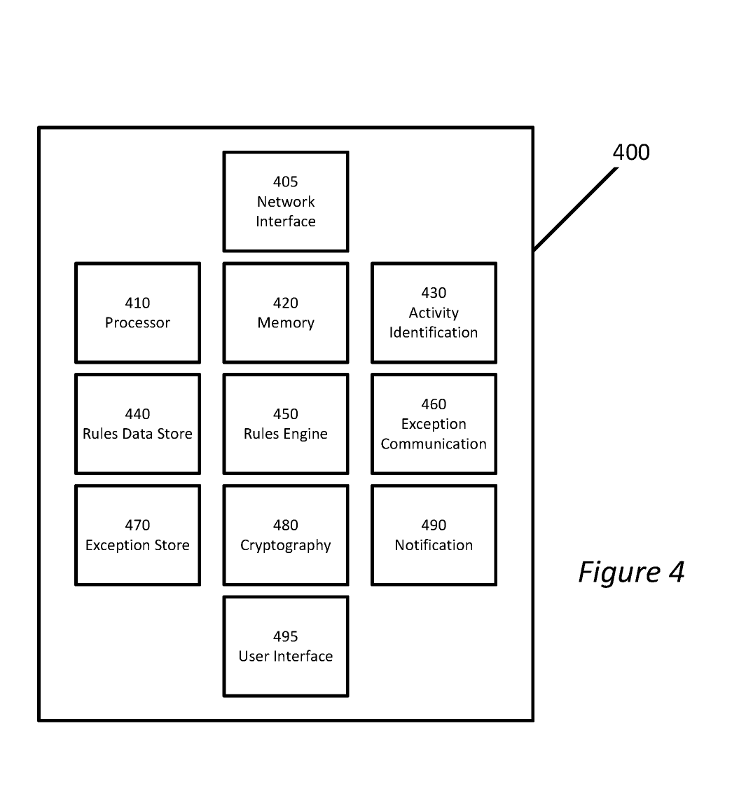

FIG. 4 illustrates an exemplary management/intercept server (FIG. 2, 250, and FIG. 4, 400). The management/intercept server (400) comprises at least one processor and/or FPGA (410), one or memories (420) (persistent and non-persistent, e.g. RAM, ROM, EEPROM, and hard disk), at least one network interface (405), and computer software executed by the processor and/or FPGA effective to send and receive network traffic with at least one intercept and monitoring device (FIG. 2, 230 and FIG. 3, 300) over a network connection. The software components of the management/intercept server comprise an activity identification component (430), a rules data store component (440), a rules engine (450), and an exception communication component (460). The management/intercept server may optionally comprise an exception store (470), a cryptographic component (480), a notification component (490490), or a user interface component (495).

Exception notifications are received from one or more of the intercept and management devices (FIG. 2, 230) by an exception communication component (460), where they are expanded as necessary, optionally stored in an exception store (470), and then passed to an activity identification component (460). The activity identification component inspects the newly reported exception, and in conjunction with the rules stored in the rules data store (440), determines the type of activity and any remedial action to take. In some implementations, the remedial action involves an immediate instruction to the sending intercept and management device to take an action or update one or more rules on the intercept and management device. In other cases, the remedial action is more delayed and may be transmitted in a return session, upon next contact with the intercept and management device, or may generate a user interface or notification alert using the optional user interface (495) and/or notification (490) component(s). These actions are managed by the exception communications component (460) in conjunction with the rules stored in the rules data store (440).

In some cases, exceptions are stored in an exception store (470) until there are enough exceptions to match against rules that may require multiple detections of a specific exception or exception type before triggering.

The exception notification component may interact with the user interface to notify a user of the management/intercept server. Users may enter additional rules in response to the notification and/or may specify additional actions that should be taken in response to a notification. If the user specifies additional actions, the management/intercept server notifies one or more intercept and management devices of the actions to take and may additionally make rules available for download. The intercept and management device then downloads these rules and actions and implements them. For example, a user may request additional collection of intercepted information related to a specific type of observed network traffic. This request would be encoded as an additional rule which is subsequently passed to the device, where it is implemented and the collected information returned to the management/information server.

It will also be recognized by those skilled in the art that, while the invention has been described above in terms of preferred embodiments, it is not limited thereto. Various features and aspects of the above described invention may be used individually or jointly. Further, although the invention has been described in the context of its implementation in a particular environment, and for particular applications, those skilled in the art will recognize that its usefulness is not limited thereto and that the present invention can be beneficially utilized in any number of environments and implementations. Accordingly, the claims set forth below should be construed in view of the full breadth and spirit of the invention as disclosed herein.

### CONCLUSION

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

What is claimed:

1. A computer-controlled electronic system for electronically managing computer network traffic among computers in an electronic computer communications network, comprising:
a computer-controlled electronic router device for enabling communications between one or more computers on an internal computer network with one or more computers on a external computer network, the router including at least one internal electronic interface configured to enable communications between a computer in the internal computer network with the router, and the router having an external electronic interface configure to enable the router to communicate with one or more devices on the external computer network;
a management-intercept server in electronic communication with the external electronic interface of the router, the management-intercept server being configure to provide instructions and programming to a network management and monitoring device and receive information about network operations collected and processed by the network management and monitoring device; and
a network management and monitoring device operably connected to the internal electronic interface of the router configured to receive provide instructions and programming from the management-intercept server and send information about network operations collected and processed by the network management and monitoring device to the management-intercept server, and the network management and monitoring device being configured to configure a routing change in the router to thereby permanently inserting itself into packet flows through the router.

2. A method for computer controlled management of computer network traffic among computers in an electronic computer communications network having a computer-controlled electronic router device for enabling communications between one or more computers on an internal computer network with one or more computers on a external computer network, the router including at least one internal electronic interface configured to enable communications between a computer in the internal computer network with the router, and the router having an external electronic interface configure to enable the router to communicate with one or more devices on the external computer network, the method comprising:
initiating a management-intercept server in electronic communication with the external electronic interface of the router, the management-intercept server being configure to provide instructions and programming to a network management and monitoring device and receive information about network operations collected and processed by the network management and monitoring device;
initiating a network management and monitoring device operably connected to the internal electronic interface of the router configured to receive provide instructions and programming from the management-intercept server and send information about network operations collected and processed by the network management and monitoring device to the management-intercept server, and the network management and monitoring device being configured to configure a routing change in the router to thereby permanently inserting itself into packet flows through the router; and
intercepting and processing electronic communications traffic reaching the router using the network management and monitoring device.
